(19) United States
(12) Patent Application Publication
(10) Pub. No.: US 2023/0289820 A1
(43) Pub. Date: Sep. 14, 2023

(54) SYSTEM AND METHOD FOR GENERATING CERTIFICATION OF GREENHOUSE GAS REDUCTION IN EFFICIENCY-OPTIMIZED PROCESSES

(71) Applicant: Volo Green LLC, Odessa, FL (US)

(72) Inventors: Paul Boardman, Sag Harbor, NY (US); Randal Melder, Tucson, AZ (US)

(73) Assignee: Volo Green LLC, Odessa, FL (US)

(21) Appl. No.: 18/181,605

(22) Filed: Mar. 10, 2023

Related U.S. Application Data
(60) Provisional application No. 63/318,757, filed on Mar. 10, 2022.

(51) Int. Cl. G06Q 30/018; G06Q 20/36

(52) U.S. Cl. CPC G06Q 30/018; G06Q 20/3672; G06Q 2220/00

(57) ABSTRACT

Certain aspects of the present disclosure provide techniques for generating certification of greenhouse gas reduction. An example method comprising collecting first sensor data regarding a greenhouse gas (GHG) emission level of a process at a first time and establishing a baseline GHG emission metric based on the first sensor data. The method also includes implementing a change to at least one step of the process. Further, the method includes collecting second sensor data regarding the GHG emission level of the process at a second time after the first time, and calculating an updated GHG emission metric based on the second sensor data. The method includes, in response to the updated GHG emission metric being less than the baseline GHG emission metric, minting an exhaustible non-fungible token with a value representing a difference between the updated GHG emission metric and the baseline GHG emission metric.

### CROSS-REFERENCE TO RELATED APPLICATIONS

This application claims priority to U.S. Provisional Application No. 63/318,757 entitled, “System and Method for Generating Certification of Greenhouse Gas Reduction in Efficiency-Optimized Processes,” filed on Mar. 10, 2022, which is hereby incorporated by reference in its entirety.

### TECHNICAL FIELD

This disclosure generally relates to systems and methods for generating certification of greenhouse gas reduction in efficiency-optimized processes, and, more particularly, to systems and methods for generating auditable and tokenized certification of carbon dioxide reduction in efficiency-optimized logistics-related processes.

### BACKGROUND

So-called “greenhouse gases” are gases which are believed to trap solar radiation (i.e., heat) within the atmosphere; thereby making the planet warmer and contributing to climate change. Greenhouse gases are generally thought to include, inter alia, carbon dioxide (CO2), methane (CH4), nitrous oxide (N2O) and fluorinated gases such as hydrofluorocarbons, perfluorocarbons, sulfur hexafluoride, and nitrogen trifluoride.

Of these greenhouse gases, perhaps none has garnered more attention than carbon dioxide—the reduction and sequestration of which has become the hallmark of many prominent environmental international treaties and national laws/policies. As but one recent example, the 2015 Paris Agreement includes a number of provisions dealing with the carbon dioxide; including a provision to reduce carbon output “as soon as possible.”

In a policy effort to both incentivize carbon dioxide reduction and monetize carbon dioxide sequestration, various public and private organizations have devised methods of marketing “carbon credits.” Trade in carbon credits began following the 1997 Kyoto Protocol which employed a “Clean Development Mechanism” under which industrialized countries were allowed to reduce emissions abroad (where doing so might be less expensive than domestic reductions), such as by planting trees in developing countries. ² In practice, however, most carbon credit trading has been in voluntary markets where buyers (typically companies trying to offset carbon emissions) purchase carbon credits from some originating source.

Notwithstanding the above, a number of hitherto unresolved challenges have surrounded these efforts. Most notably, there have been no reliable, standardized and auditable means of determining greenhouse gas reduction applicable to a wide variety of industries. There have also been a number of problems (including outright fraud) in the creation of things like carbon credits. Indeed, even pro-environmental groups such as Friends of the Earth note that: “Most ‘emission reduction’ credits are ‘fake,’ from projects that do not actually reduce emissions. Billions of dollars have been transferred from taxpayers to undeserving project developers and a growing army of carbon brokers and consultants.”

Indeed, a reliable, universally applicable means of determining greenhouse gas reduction (including, perhaps most importantly, carbon dioxide reduction) is needed in order to effectively create meaningful markets in greenhouse gas credits. The universality of such a means is particularly important given the variety of greenhouse gas producing sectors of the global economy. By way of example, according to the U.S. Environmental Protection Agency, the largest sources of greenhouse gas emissions in the U.S. as of 2019 (i.e., pre-COVID-19 pandemic) were: (i) transportation (accounting for approximately 29% of emissions); (ii) electricity production (accounting for approximately 25% of emissions); (iii) industrial applications (accounting for approximately 23% of emissions); (iv) commercial and residential applications (accounting for approximately 13% of emissions); and agricultural applications (accounting for approximately 10% of emissions).

Thus, a means for determining greenhouse gas reduction in sectors as varied as transportation, energy production, agriculture and industrial, commercial, and residential sectors is needed.

### SUMMARY

Disclosed herein is a system and method for generating certification of greenhouse gas reduction in a multitude of efficiency-optimized processes including, without limitation, transportation, energy production, agricultural, industrial, commercial, and residential processes. More specifically, the disclosure relates to systems and methods for generating auditable and tokenized certification of carbon dioxide reduction in a multitude of logistics-related processes which is a core component of the transportation sector (which sector, as noted above, comprises the largest source of pre-COVID 19 pandemic greenhouse gas emissions within the United States). This empowers the reduction of greenhouse gases—most notably a reduction of the carbon footprint—for significant processes from a multitude of economic sectors.

As described herein, the systems and methods for generating certification of greenhouse gas reduction in efficiency-optimized processes will be transformative within an almost unlimited number of processes in all industries, i.e., it has the power to be transformative within any process where a user desires to better understand and, ultimately, reduce greenhouse gases associated with such process. This could range from greenhouse gas em1ss10ns generated through livestock production or power plant operation to heavy manufacturing or producing/refining oil and natural gas.

An example method include collecting, from one or more sensors, first sensor data regarding a greenhouse gas (GHG) emission level of a process at a first time, and establishing a baseline GHG emission metric based on the first sensor data. The method includes implementing a change to at least one step of the process. The method also includes collecting from the one or more sensors, second sensor data regarding the GHG emission level of the process at a second time after the first time, and calculating an updated GHG emission metric based on the second sensor data. Additionally, the method includes, in response to the updated GHG emission metric being less than the baseline GHG emission metric, minting an exhaustible non-fungible token with a value representing a difference between the updated GHG emission metric and the baseline GHG emission metric.

In some examples, the method includes listing, at a third time after the second time, the exhaustible non-fungible token on a market. In some examples, the method includes causing, at a fourth time after the third time, the exhaustible non-fungible token to execute code to flag the exhaustible non-fungible token as untradable. In some examples, the code causes the exhaustible non-fungible token to irreversibly alter at least one characteristic of the exhaustible non-fungible token to indicate that the exhaustible non-fungible token to is untradeable. In some examples, the method includes refusing, at a fifth time after the fourth time, to list the exhaustible non-fungible token on the market when the exhaustible non-fungible token is flagged as untradeable. In some examples, the process is managing a fleet of vehicles and the baseline and updated GHG emission metrics are based on fuel consumption of the fleet of vehicles. In some examples, implementing the change to the at least one step of the process includes reducing an average idle time of vehicles in the fleet of vehicles.

An example system includes at least one local memory, and at least one processor coupled to the at least one local memory, the at least one processor and the at least one local memory. The system collects, from one or more sensors, first sensor data regarding a greenhouse gas (GHG) emission level of a process at a first time, and establishes a baseline GHG emission metric based on the first sensor data. The system implements a change to at least one step of the process. Additionally, the system collects from the one or more sensors, second sensor data regarding the GHG emission level of the process at a second time after the first time, and calculates an updated GHG emission metric based on the second sensor data. In some example, in response to the updated GHG emission metric being less than the baseline GHG emission metric, the system mints an exhaustible non-fungible token with a value representing a difference between the updated GHG emission metric and the baseline GHG emission metric.

In some examples, the system lists, at a third time after the second time, the exhaustible non-fungible token on a market. In some examples, the system causes, at a fourth time after the third time, the exhaustible non-fungible token to execute code to flag the exhaustible non-fungible token as untradable. In some examples, the code causes the exhaustible non-fungible token to irreversibly alter at least one characteristic of the exhaustible non-fungible token to indicate that the exhaustible non-fungible token to is untradeable. In some examples, the system refuses, at a fifth time after the fourth time, to list the exhaustible non-fungible token on the market when the exhaustible non-fungible token is flagged as untradeable. In some examples, the process is managing a fleet of vehicles and the baseline and updated GHG emission metrics are based on fuel consumption of the fleet of vehicles. In some examples, to implement the change to the at least one step of the process, the system operates at least one vehicle elevator to reduce an average idle time of vehicles in the fleet of vehicles.

A non-transitory computer readable medium comprising instructions that, when executed, cause a system to collect, from one or more sensors, first sensor data regarding a greenhouse gas (GHG) emission level of a process at a first time and establish a baseline GHG emission metric based on the first sensor data. The instructions also cause the system to implement a change to at least one step of the process. Additionally, the instructions cause the system to collect from the one or more sensors, second sensor data regarding the GHG emission level of the process at a second time after the first time, and calculate an updated GHG emission metric based on the second sensor data. The instruction cause the system to, in response to the updated GHG emission metric being less than the baseline GHG emission metric, mint an exhaustible non-fungible token with a value representing a difference between the updated GHG emission metric and the baseline GHG emission metric.

### DESCRIPTION OF THE DRAWINGS

The appended figures depict certain aspects of the one or more embodiments and are therefore not to be considered limiting of the scope of this disclosure.

FIG. 1 is a flowchart illustrating an example method to perform the certification of greenhouse gas reduction in an efficiency-optimized process.

FIG. 2A is a process chart more fully illustrating the steps to determine the reduction of greenhouse gas emissions in an efficiency-optimized process, according to the teachings of this disclosure.

FIG. 2B is a process chart more fully illustrating the steps to certify a reduction of greenhouse gas emissions in an efficiency-optimized process, according to the teachings of this disclosure.

FIG. 3 is an exemplary process chart more fully illustrating the steps to certify a reduction of greenhouse gas emissions in an efficiency-optimized logistics process, namely, determining mean daily fuel savings for a population of fleet vehicles, according to the teachings of this disclosure.

FIG. 4 is a depiction of the system architecture to implement the systems and methods for use in efficiency-optimized logistics processes, namely, processes involving fleet vehicles, according to the teachings of this disclosure.

FIG. 5A is an exemplary process chart more fully illustrating the steps to determine the reduction of greenhouse gas emissions in an efficiency-optimized energy production process, namely, determining the reduction of greenhouse gas emissions in the operation of a natural gas power plant, according to the teachings of this disclosure.

FIG. 5B is an exemplary process chart more fully illustrating the steps to certify a reduction of greenhouse gas emissions in an efficiency-optimized energy production process, namely, certifying the reduction of greenhouse gas emissions in the operation of a natural gas power plant, according to the teachings of this disclosure.

FIG. 6 is an exemplary process chart more fully illustrating the steps to certify a geothermal carbon-cycle process including energy production data calculation and validation/certification, according to the teachings of this disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In one example, the systems and methods for generating certification of greenhouse gas reduction in efficiency-optimized processes are applied to logistics-related processes. Traditional logistics operations such as fleet vehicle operations are time consuming and result in relatively high greenhouse gas emissions—particularly carbon dioxide emissions. Currently, many fleet vehicle operations (e.g., delivery-oriented companies such as AMAZON®, common carriers such as FEDERAL EXPRESSO, UNITED PARCEL SERVICE®, USPS®, etc.) go through a number of inefficient steps in the final step of the delivery process (commonly referred to as “Last Mile Logistics” within the industry). For example, it is common for a fleet vehicle driver at such facilities to: (i) park his or her personal vehicle in a large common parking lot then walk to a rendezvous point; (ii) take a shuttle or bus from the rendezvous point to a fleet vehicle parking facility; (iii) check out an assigned fleet vehicle; (iv) drive the fleet vehicle to a loading dock where the fleet vehicle is loaded with cargo; and (v) exit the fleet vehicle parking facility and begin his or her intended route. At the end of the driver's shift, the entire process is then repeated in reverse, with the driver signing in, returning the vehicle to the fleet vehicle parking facility, taking a shuttle or bus to the rendezvous point, then returning to his or her personal vehicle. At each stage of this process, long lines can form—particularly in large, high-traffic last mile logistics facilities. During much of this process, fleet vehicles are idling—burning fuel at cost to the fleet operator while emitting greenhouse gases.

The systems and methods for generating certification of greenhouse gas reduction in efficiency-optimized processes described herein help resolve this issue by creating a system and method for measuring and certifying the impact of various greenhouse gas reduction techniques, and tokenizing the certification such that the reduction can be audited, tracked, stored, traded and commoditized.

The systems and methods for generating certification of greenhouse gas reduction in efficiency-optimized processes may be a vertically integrated, auditable system and method for the automated certification and confirmation of carbon dioxide reduction and/or sequestration.

Initially, the system and method utilize algorithmic formulas to measure, reconcile, confirm, and quantify a “baseline” based on then-current use (e.g., measuring the greenhouse gas emissions from a herd of livestock or a fleet of last mile logistics vehicles). After some optimization is made (e.g., switching the livestock to a low-methane feed source or optimizing tire pressure for fleet vehicles), the system and method includes a post-optimization comparative metrics—looking at operational, technological, behavioral and process changes which reduced carbon dioxide or other greenhouse gas emissions. Depending on the particular application, this process can be partially or fully automated. For example, much of the data inputs needed in logistics and fleet-vehicle related applications can be recorded automatically using cameras and audio-visual sensors (e.g., a license plate reader), proximity sensors (e.g., an infrared sensor to detect when a fleet vehicle arrives at a loading bay), or other similar technologies (e.g., on-board diagnostics (OBD) data generated by a vehicle's computer system and read using an OBD2 software package read with either a wired or a telemetered (e.g., Bluetooth® or WiFi) OBD2 adaptor. This data can then be interpreted using various quality assurance/quality control metrics specific to each application. For example, in an application to a coal fired power plant, the amount of contaminants removed by air scrubbers would be something that could be measured and interpreted in view of various governmental standards. In another application to a fleet of a last mile logistics operation, the mileage on each vehicle could be interpreted in view of various vehicle maintenance schedules.

Lastly, the system quantifies the reduction and stores this information in a digital record, e.g., through the use of a non-fungible token (“NFT”) or other data unit stored on a blockchain or other form of digital ledger. Thus, the system and method bridge three “dimensions,” namely: (i) a data dimension (e.g., binary data from various monitored sensor outputs); (ii) a physical dimension (e.g., logical party engagement for quality assurance/quality control cross confirmation); and (iii) a behavioral dimension (e.g., targeted mapping of human interaction with a multitude of processes and machines in the transportation, electricity production, industrial, commercial, residential, agricultural and other industries.

Unfortunately, many so-called “green technologies” have dubious—or even outright negative—impacts on the environment. For example, certain technologies may appear to generate carbon-zero electricity or operate at a carbon-zero level, while the hardware behind such technologies actually requires a great deal of carbon to manufacture. If only a “snapshot” of such a technology is used to determine the technology's environmental impact, a very incomplete picture is generated—inhibiting relevant stakeholders from adequately evaluating the overall environmental impact of the technology. For example, only measuring carbon dioxide emissions from an electric car during the car's operation will result in a very different overall environmental impact than including the various carbon dioxide emissions that went into the manufacturing of the car, the processing of raw materials for the car, the mining of raw materials for the car, etc. The system and methods described herein open new horizons for more accurately determining the impact, if any, of various optimization changes to processes such as seeking to implement changes in order to reduce greenhouse gas emissions. Carrying through the electric car example noted above, systems and methods described herein may be used to accurately measure and record the total greenhouse gas emissions related to every process which lead up to the manufacturing of the electric car. The systems and methods described herein may also be used to: (a) collect data about a current, fossil-fuel burning car; (b) record the impact, if any, of switching such fossil-fuel burning car to the electric car; and (c) storing this data in the form of an NFT. In this way, stakeholders could more fully understand and optimize a near-infinite number of processes—including optimization from the perspective of reducing or sequestering greenhouse gas emissions such as carbon dioxide.

On a larger scale (e.g., a last mile logistic operator with a fleet of hundreds if not thousands of vehicles), the systems and methods described herein may be used to produce germane energy consumption related metrics such as the rate of fossil fuel or electric consumption. The daily mean fleet fuel consumption (μ) is the sum of all vehicle fuel consumption divided by the total fleet population (N) as set forth in Equation 1 below.

$$μ = {\sum }_{i = 1}^{N} ( \frac{{f}_{i}}{N} ) \qquad Equation 1$$

In Equation 1, ƒ is fuel consumption and i is each vehicle in the fleet population (N).

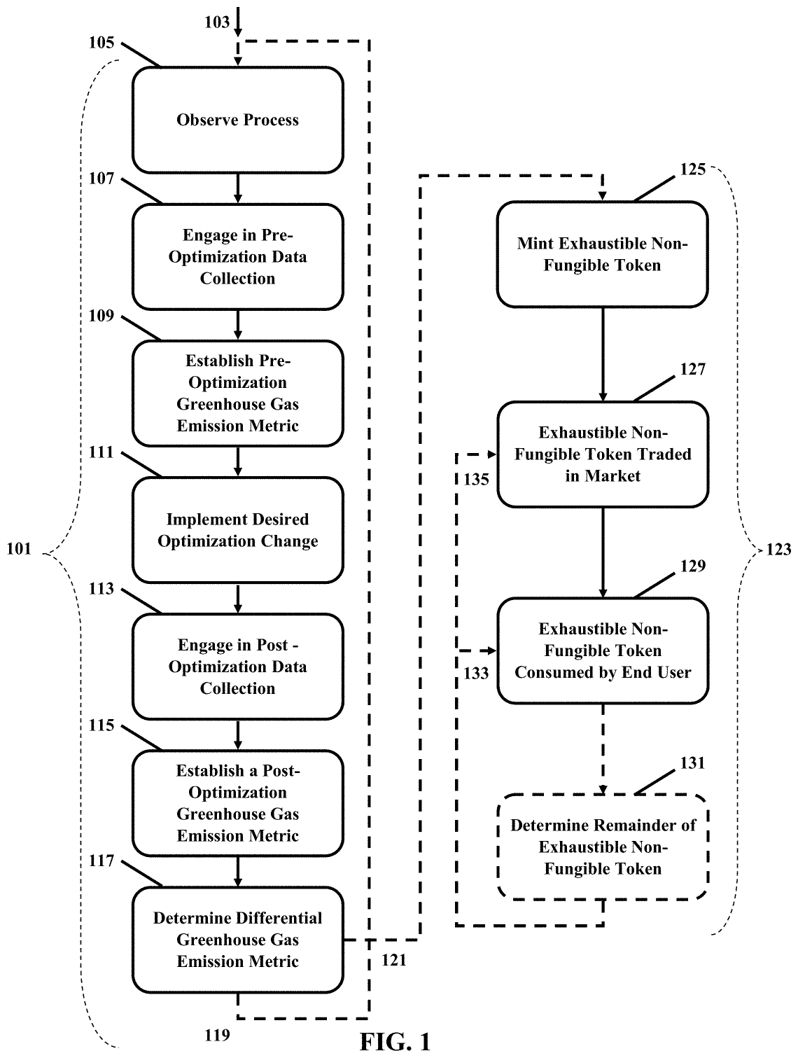

FIG. 1 is a flowchart illustrating an example method to perform the certification of greenhouse gas reduction in an efficiency-optimized process. In the illustrated example, the certification process includes two portions, namely, a performance measurement portion 101 and an optional certification portion 123.

With respect to the performance measurement portion 101, a process input 103 (i.e., the particular process which a user wishes to have evaluated for greenhouse gas reduction) is observed (block 105). Depending on the nature of the process input 103, a time period (“T”) and a variety of key performance indicators (“KPI”) could be deemed relevant by the user based on such process observation. For example, in a logistics I fleet, a relevant time period might be the useful life of a vehicle, an annual period of time, a one month period of time, a weekly period of time, a daily period of time or some other user-selected duration. Similarly, in a logistics/fleet related application, relevant key performance indicators could include, for example, (i) fuel consumption (for fossil fuel powered vehicles), (ii) battery consumption (electric vehicles), (iii) the time a fleet vehicle is idling, (iv) the time required for a driver to park his or her personal vehicle or otherwise arrive at a rendezvous point, (v) the time between when a driver arrives at a rendezvous point and the time the driver receives access to a fleet vehicle, (vi) the time needed for a driver to check out an assigned fleet vehicle, (vii) the time needed to load a fleet vehicle with cargo, (viii) the time needed for a driver to exit a fleet vehicle parking facility and begin his or her intended route, (ix) the time needed for a driver to reenter a fleet vehicle parking facility at the end of a route, (x) the time needed for a driver to exit the vehicle and return to the rendezvous point, (xi) the time required for a driver to reenter his or her personal vehicle or otherwise depart the rendezvous point, (xii) miles consumed per unit time (e.g., per day, per week, per month, etc.), (xiii) Diagnostic Trouble Codes (“DTCs”) encountered in each fleet vehicle (i.e., indicators of the state of the vehicle), (xiv) vehicle wear/maintenance (including, without limitation, the greenhouse gas emissions related to replacement parts/maintenance labor), (xv) vehicle depreciation, (xvi) driver time in vehicle, (xvii) vehicles needing repair, (xviii) carbon monoxide output, (xix) carbon dioxide exhaust output, and/or (xx) any other metric recorded by the vehicle's on-board diagnostics (“OBD”) system. In some examples, one or more of the above-mentioned data points could be collected by an OBD2 software package and read with either a wired or a telemetered (e.g., Bluetooth® or WiFi OBD2) adaptor.

Next, data is collected pre-optimization in order to establish a relevant baseline (block 107). The baseline may be measurements taken concerning the various key performance indicators described above over some relevant time period. This data collection can be actual (i.e., measuring and recording certain actual data), logical (i.e., calculated based on certain assumptions) or a hybrid of the two. In a logistics/fleet related application, this might include measuring one or more of the relevant key performance indicators (including, without limitation, the exemplar key performance indicators noted above). For example, this might mean measuring and recording driver's time in a vehicle, the amount of fuel expended while the vehicle is idling in line to exit the logistics facility or using motion-sensing cameras to determine when a vehicle has been fully loaded. In a logistics/fleet related application, this might also include logical determinations such as a calculation of miles per gallon, calculating the average speed of a vehicle during a given shift or estimating the wear and tear on a vehicle over a given time period.

Using the collected pre-optimization data, the example method then determines the amount of greenhouse gases 109 which correspond to such pre-optimization data. In a logistics/fleet related application, for example, the total amount of carbon dioxide emitted from a gasoline burning vehicle over a given delivery route could be calculated using: (a) the average quantity of carbon dioxide emitted per gallon from a particular brand/octane of gasoline and; (b) the total number of gallons of gasoline expended during the course of such route (measured at block 107).

Next, a desired optimization change is implemented (block 111). In a logistics/fleet related applications, for example, this might mean switching to a different source of fuel (e.g., switching from a gasoline to natural gas powered vehicle).

Next, post-optimization data is collected from the process (block 113). Generally, the same data points collected and recorded in during pre-optimization data (e.g., at block 107) would also be collected and recorded in this post-optimization data. Next, using the collected post-optimization data, the method then determines the amount of greenhouse gases which correspond to such post-optimization data (block 115). In the logistics/fleet related application, for example, the total amount of carbon dioxide emitted from the new natural gas powered vehicle over a given delivery route could be calculated using: (a) the average quantity of carbon dioxide emitted per unit of natural gas from a particular and; (b) the total number of units of natural gas expended during the course of such route (e.g., as measured at block 113).

Next, the difference, if any, between the pre-optimization greenhouse gas emission (e.g., measured at block 109) and the post optimization greenhouse gas emission (e.g., measured at block 115) are compared in order to determine the impact, if any, of the implemented optimization with respect to the greenhouse gases associated with the underlying process. In the logistics/fleet related application, for example, the total amount of carbon dioxide emitted from the gasoline powered vehicle over a given route could be compared with the total amount of carbon dioxide emitted from the natural gas powered vehicle over the same route and a total impact determined. Many optimizations such as switching one vehicle for another may have many input and many output datasets. In another, more simplistic, example, something as minor as tire pressure in a fleet vehicle could be optimized- and the results of that optimization on fuel efficiency and, hence, greenhouse gas emissions—could be determined.

In some examples, the steps at blocks 105 through 117 could be repeated for any number of optimizations. In the logistics/fleet related application, for example, a multitude of individual optimizations could be made such as charging electric vehicles during non-peak hours, reducing vehicle weight, reducing driver wait time while loading cargo, etc. For each such desired optimization change, systems and methods described herein can iteratively evaluate and reevaluate the impact—with the pre-optimization data collection step 107 constantly updating based on the most recent version of the process.

In some examples, the reduction of greenhouse gas emissions is recorded (block 119). In some examples, this recordation is done in the form of a Non-Fungible Token (“NFT”) 125. In some examples (e.g., as shown in FIG. 1), the process of minting the NFT could be done in such a way that the NFT is an “exhaustible” token, i.e., that the token can be depleted or “used up” in the course of offsetting other greenhouse gas emissions (sometimes referred to as an “eNFT”). This eliminates the problem of “double selling” carbon credits (e.g., when a confidence man sells the same carbon offset credits from allegedly planting trees in the developing world to multiple buyers).

In such examples, such exhaustible NFTs can be actively bought, sold, optioned and otherwise traded in a marketplace 127. This helps facilitate the efficient distribution of carbon credits or other greenhouse gas emission credits based on market principles.

In some examples, such exhaustible NFTs can be conveyed to an “end user” 129, i.e., an individual or entity which desires to purchase carbon credits or other greenhouse gas emission credits in order to effect a net reduction in that individual or entity's overall carbon footprint (or other greenhouse gas footprint). For example, a net-carbon-positive-factory wishing to become carbon-neutral may wish to purchase a certain quantify of carbon credits in order to reach a net-neutral position. Given the exhaustible nature of the NFTs, such an offset could be appended to the blockchain ledger and the corresponding NFT(s) depleted accordingly.

In some examples, depending on the amount of carbon dioxide or other greenhouse gases being offset, a remainder of an exhaustible NFT could be determined (block 131). For example, a net-carbon-positive-factory wishing to offset one ton of carbon dioxide which purchases an NFT representing a reduction or sequestration of ten tons of carbon dioxide: (a) would report this offset to the blockchain ledger; and (b) the blockchain ledger would update the “value” of the exhaustible NFT by reducing the recorded value of the NFT to nine tons of carbon dioxide.

Optionally, an exhaustible NFT which has been reduced in value (e.g., at block 131) could either be retained by the end user for further future use 133 or resold in the market 135.

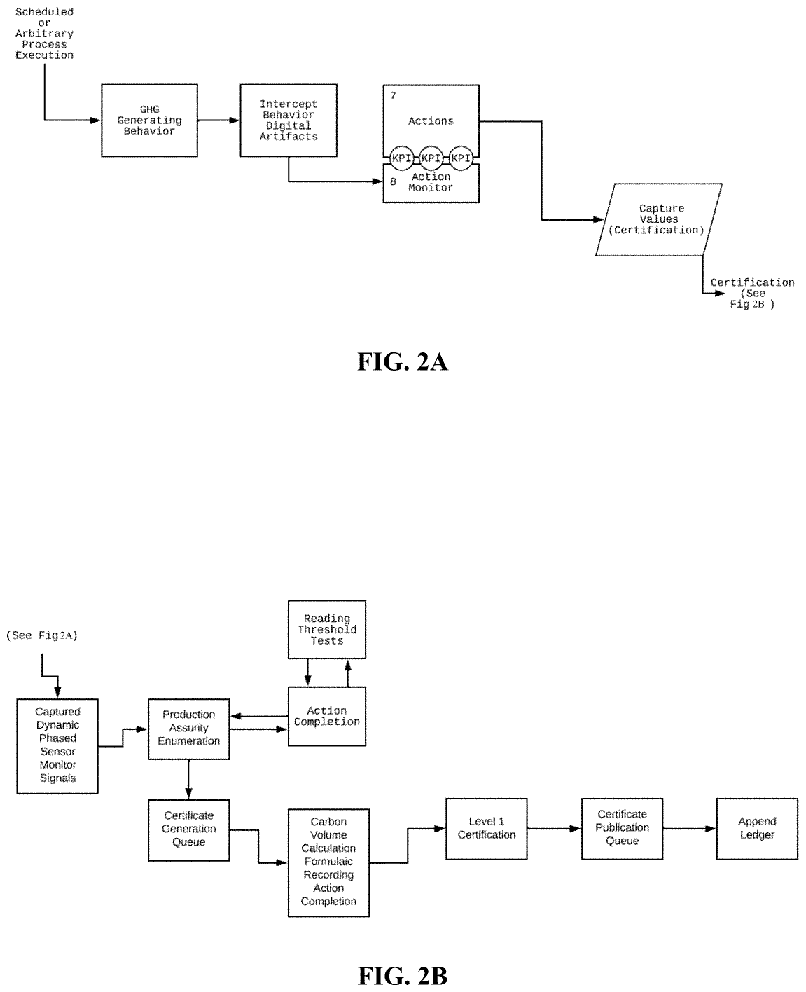

FIG. 2A illustrates an example process for determining the reduction of greenhouse gas emissions in an efficiency-optimized process. FIG. 2B illustrates an example process for certifying a reduction of greenhouse gas emissions in an efficiency-optimized process. As used herein, a key performance indicator (KPI) is a metrics that defines an expectation of acceptable operation, usually in numeric terms. For example, a reading may indicate that liquid water pressure is currently 60 psi. A standard operating procedure (SOP) is a document explaining the prescription for responding to a specific event in terms of satisfying company policies. For example, an SOP may describe how to proceed if liquid water pressure is less than 32 psi or greater than 80 psi.

As shown in FIGS. 2A and 2B, such a process could include (i) greenhouse gas (GHG) generating behavior, including industrial process where the product or byproduct is a greenhouse gas, (ii) intercepting behavior digital artifacts, including a monitoring system that accumulates sensor data and over time (sometimes referred to as “sensor data harvesting”), (iii) action monitoring of one or more KPis that indicate operational integrity or productive measure, such as temperatures, pressure, volume throughput, chemical makeup, etc., (iv) captured dynamic phased sensor monitoring that maps the accumulation of KPis into a certificate definition used in algorithms to derive carbon savings, production, offset or exchange, (v) production assurity enumeration to cycle through captured evidence to complete actions when the actions successfully satisfy predefined action evidence boundaries, (vi) action completion to submit evidence to the satisfaction of the action input requirements (vii) reading threshold testing (e.g., according to an SOP) to ensure that each action's individual required boundaries are satisfied post completion and to perform final checks that actions required for certification are completed, (viii) a certificate generation queue to processor driving certificate generation; (ix) a carbon calculation process that uses action evidence in algorithms to calculate carbon saving, production, offset and/or exchange, (x) certificate generation to convert the compilation of action evidence and attestation data into an artifact that is a unique digital file, (xi) a publication queue that cycles through certificates waiting to be made available, that drives the “Append Ledger” publisher, (xii) an append ledger that publishes certificate to inventory, catalog, blockchain and other mediums of exchange; making certificates either publicly or privately available.

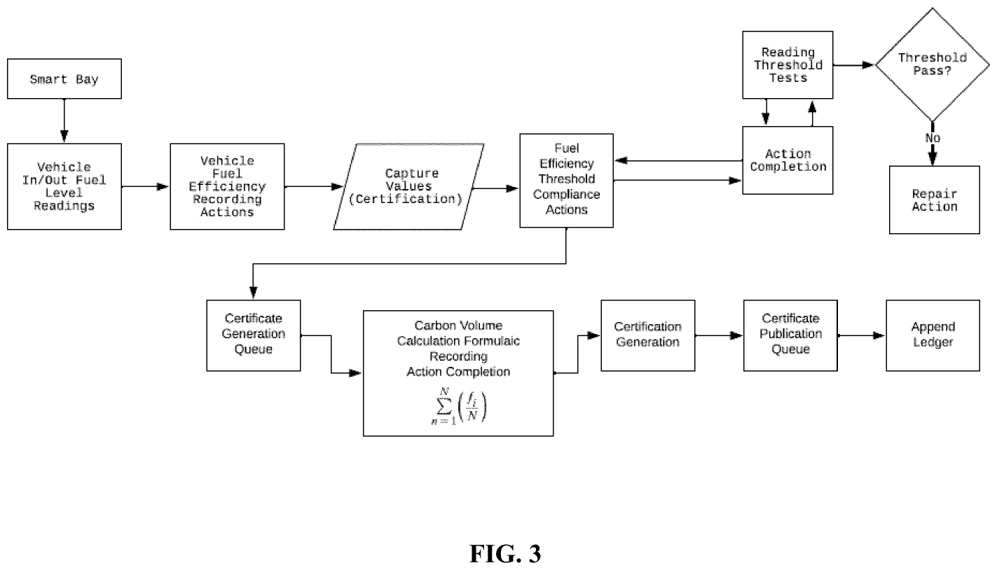

FIG. 3 is an exemplary process chart more fully illustrating the steps to certify a reduction of greenhouse gas emissions in an efficiency-optimized logistics process, namely, determining mean daily fuel savings for a population of fleet vehicles. As shown in FIG. 3, such an exemplary process could include (i) an intelligent vehicle parking device that senses a vehicle embark/debark, identifies vehicle and initiates vehicle interrogation, (ii) vehicle in/out fuel level readings to measure current vehicle fuel level and distance traveled, (iii) a capture certifier to the recorded amount of fuel is compared to last fuel level and calculate a consumption value of the difference derived from the two readings and, in some examples, calculate a fleet mean consumption and distance traveled are computed, (iv) fuel efficiency threshold compliance manager that compares fuel consumption and distance traveled metrics against manufacturer consumption values as well as fleet mean consumption, (v) am action complete manager that verifies that evidence is submitted to the satisfaction of the action input requirements, (vi) a reading threshold test manager that tests each action's individual required boundaries for satisfaction per SOP post completion and performs final checks that for verification that certification is completed (vii) certificate generation queue to processor driving certificate generation; (ix) a carbon calculation process that uses action evidence in algorithms to calculate carbon saving, production, offset and/or exchange, (x) certificate generation to convert the compilation of action evidence and attestation data into an artifact that is a unique digital file, (xi) a publication queue that cycles through certificates waiting to be made available, that drives the “Append Ledger” publisher, (xii) an append ledger that publishes certificate to inventory, catalog, blockchain and other mediums of exchange; making certificates either publicly or privately available.

The fuel efficiency threshold compliance manager analyzes the fuel consumption data compared to thresholds to advance to the certification queue. In some examples, it the fuel consumption data does not meet the threshold, repair actions are assigned and process terminates.

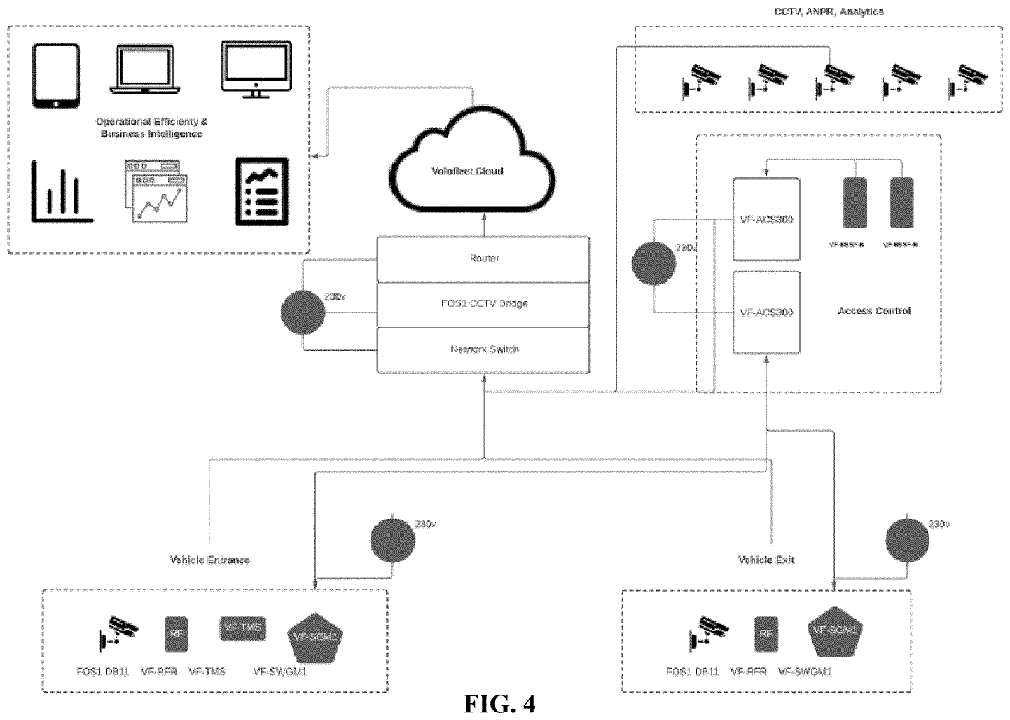

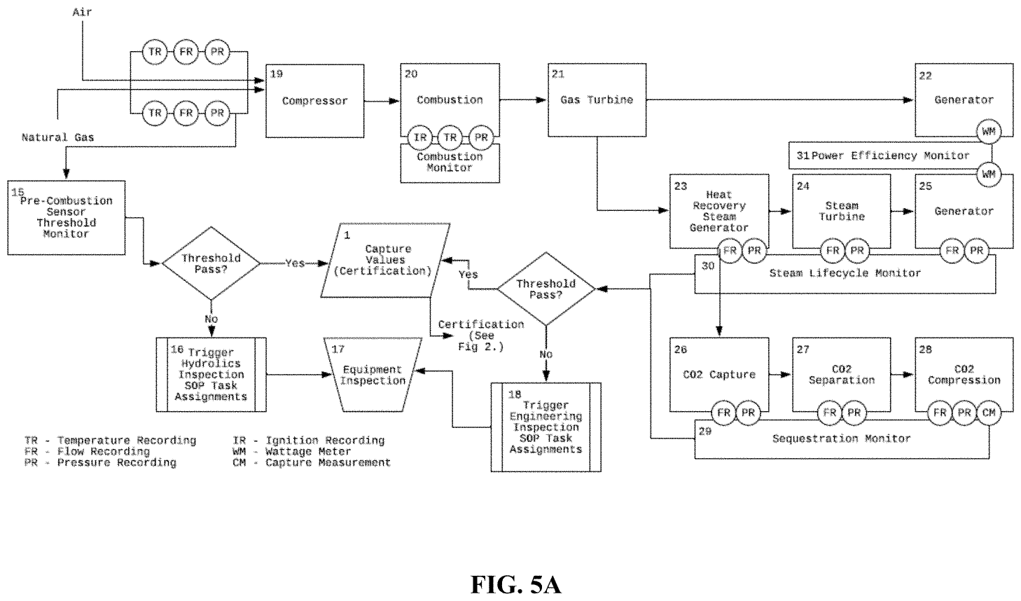

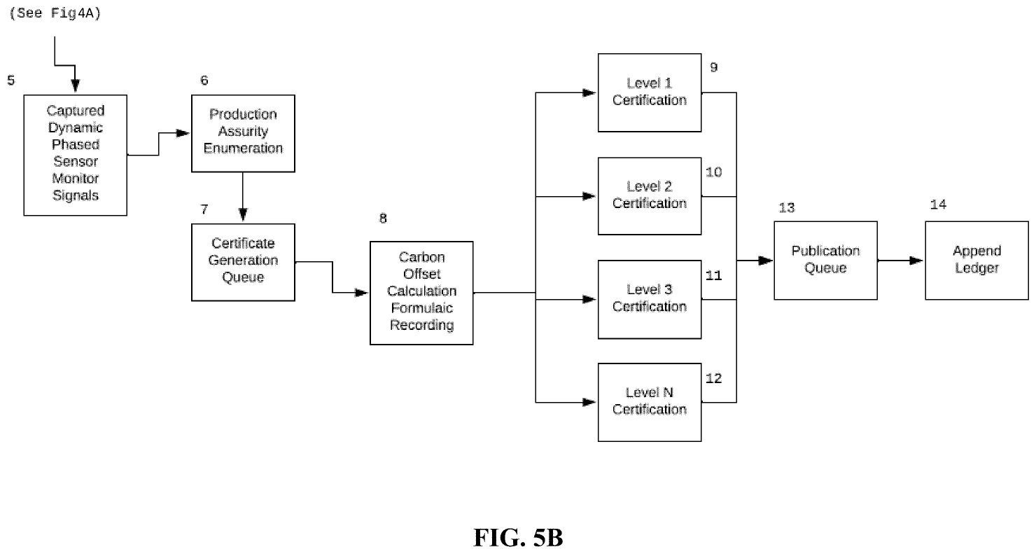

FIG. 4 is a depiction of the system architecture used to implement the systems and methods described herein for use in efficiency-optimized logistics processes, namely, processes involving fleet vehicles

FIG. 5A is an exemplary process chart more fully illustrating the steps to determine the reduction of greenhouse gas emissions in an efficiency-optimized energy production process, namely, determining the reduction of greenhouse gas emissions in the operation of a natural gas power plant.

FIG. 5B is an exemplary process chart more fully illustrating the steps to certify a reduction of greenhouse gas emissions in an efficiency-optimized energy production process, namely, certifying the reduction of greenhouse gas emissions in the operation of a natural gas power plant.

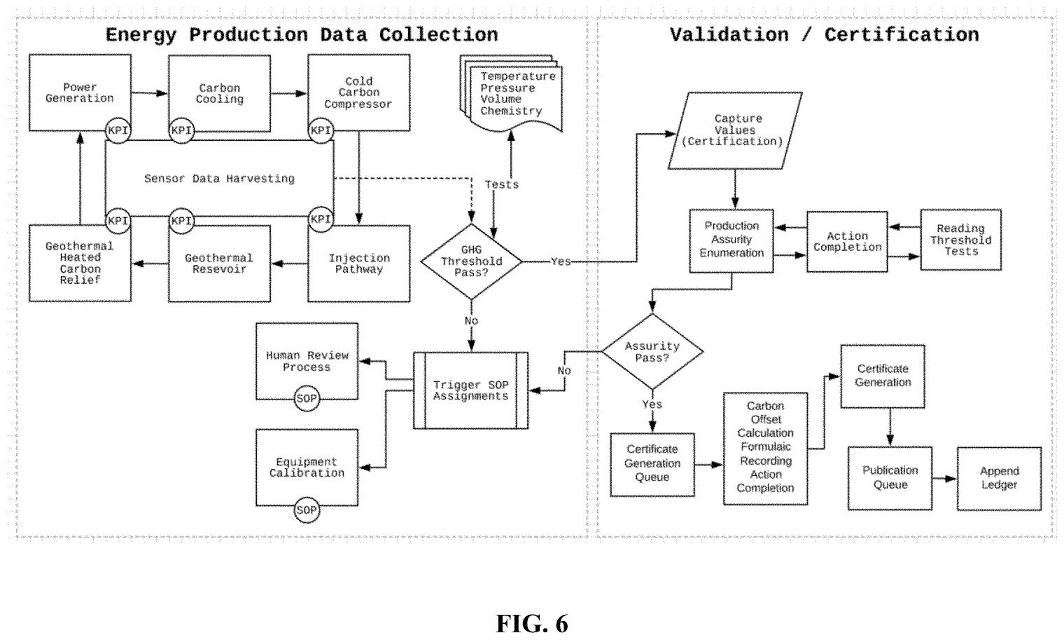

FIG. 6 is an exemplary process chart more fully illustrating the steps to certify a geothermal carbon-cycle process including energy production data calculation and validation/certification. As shown in FIG. 6, such an exemplary process could include (i) a power generation system with an electricity producing motor component, (ii) a carbon cooling system with a phase post motor where byproducts require cooling, (iii) a cold carbon compressor to liquefy carbon, (iv) and injection pathway that sending liquefied carbon to earth, (v) a geothermal reservoir to store the carbon, (vi) a geothermal heated carbon relief with a chimney or stovepipe of sorts serving as a path where heated carbon escapes the earth, (vii) a monitoring system to accumulate sensor data and over time, (viii) a threshold monitor to indicate whether system readings are within expected tolerances, (ix) a sensor monitor to monitor operational integrity or productive measure of one or more associated KPis, such as temperatures, pressure, volume throughput, chemical makeup, etc., (x) a pre certification monitor to map the accumulation of KPis into a certificate definition, where the accumulation of values are used in algorithms to derive carbon savings, production, offset or exchange (xi) a production assurity enumerator to cycling through captured evidence to complete actions; expecting all actions to successfully satisfy predefined action evidence boundaries, (xii) an action completion manager to compile a individual body of work expected to have evidence submitted to the satisfaction of the action input requirements, (xiii) (13) a reading threshold tester to determine when each action's individual required boundaries are satisfied per SOP post completion (xiv) an assurity monitor to perform a final check that actions required for certification are completed, (xv) a certificate generation queue including a processor driving certificate generation, (xvi) a carbon offset calculator to compile action evidence and completions to use to calculate carbon savings, production, offset and/or exchange, (xvii) a certificate generator to convert the compilation of action evidence and attestation data into an artifact that is a unique digital file, (xviii) a publication queue to cycle through certificates waiting to be made available to drives the append Ledger publisher, and (xix) an append ledger to publish certificates to inventory, catalog, blockchain and other mediums of exchange; making certificates either publicly or privately available.

In some examples, the process also includes (i) a state machine that matches task management system actions with threshold violations to trigger task assignments to predefined recipients, (ii) one or more SOPs requiring humans interaction to investigate and mitigate a reading value that is out of range, (iii) an equipment calibration to make adjustments or report to equipment to ensure it is measuring to proper tolerances.

It is to be understood that while a preferred embodiment of the invention is illustrated, it is not to be limited to the specific form or arrangement of parts herein described and shown. It was be apparent to those skilled in the art that various changes may be made without departing from the scope of the invention and the invention is not to be considered limited to what is shown and described in the specification and drawings.

What is claimed is:

1. A method, comprising:
collecting, from one or more sensors, first sensor data regarding a greenhouse gas (GHG) emission level of a process at a first time;
establishing a baseline GHG emission metric based on the first sensor data;
implementing a change to at least one step of the process;
collecting from the one or more sensors, second sensor data regarding the GHG emission level of the process at a second time after the first time;
calculating an updated GHG emission metric based on the second sensor data; and
in response to the updated GHG emission metric being less than the baseline GHG emission metric, minting an exhaustible non-fungible token with a value representing a difference between the updated GHG emission metric and the baseline GHG emission metric.

2. The method of claim 1, further comprising listing, at a third time after the second time, the exhaustible non-fungible token on a market.

3. The method of claim 2, further comprising causing, at a fourth time after the third time, the exhaustible non-fungible token to execute code to flag the exhaustible non-fungible token as untradable.

4. The method of claim 3, wherein the code causes the exhaustible non-fungible token to irreversibly alter at least one characteristic of the exhaustible non-fungible token to indicate that the exhaustible non-fungible token to is untradeable.

5. The method of claim 3, further comprising refusing, at a fifth time after the fourth time, to list the exhaustible non-fungible token on the market when the exhaustible non-fungible token is flagged as untradeable.

6. The method of claim 1, wherein the process is managing a fleet of vehicles and the baseline and updated GHG emission metrics are based on fuel consumption of the fleet of vehicles.

7. The method of claim 6, wherein implementing the change to the at least one step of the process includes reducing an average idle time of vehicles in the fleet of vehicles.

8. A system, comprising:
at least one local memory; and
at least one processor coupled to the at least one local memory, the at least one processor and the at least one local memory configured to:
collect, from one or more sensors, first sensor data regarding a greenhouse gas (GHG) emission level of a process at a first time;
establish a baseline GHG emission metric based on the first sensor data;
implement a change to at least one step of the process;
collect from the one or more sensors, second sensor data regarding the GHG emission level of the process at a second time after the first time;
calculate an updated GHG emission metric based on the second sensor data; and
in response to the updated GHG emission metric being less than the baseline GHG emission metric, mint an exhaustible non-fungible token with a value representing a difference between the updated GHG emission metric and the baseline GHG emission metric.

9. The system of claim 8, wherein in the processor is further configured to list, at a third time after the second time, the exhaustible non-fungible token on a market.

10. The system of claim 9, wherein in the processor is further configured to cause, at a fourth time after the third time, the exhaustible non-fungible token to execute code to flag the exhaustible non-fungible token as untradable.

11. The system of claim 10, wherein the code causes the exhaustible non-fungible token to irreversibly alter at least one characteristic of the exhaustible non-fungible token to indicate that the exhaustible non-fungible token to is untradeable.

12. The system of claim 10, wherein in the processor is further configured to refuse, at a fifth time after the fourth time, to list the exhaustible non-fungible token on the market when the exhaustible non-fungible token is flagged as untradeable.

13. The system of claim 8, wherein the process is managing a fleet of vehicles and the baseline and updated GHG emission metrics are based on fuel consumption of the fleet of vehicles.

14. The method of claim 13, wherein to implement the change to the at least one step of the process, the processor is further configured operate at least one vehicle elevator to reduce an average idle time of vehicles in the fleet of vehicles.

15. A non-transitory computer readable medium comprising instructions that, when executed, cause a system to:
collect, from one or more sensors, first sensor data regarding a greenhouse gas (GHG) emission level of a process at a first time;
establish a baseline GHG emission metric based on the first sensor data;
implement a change to at least one step of the process;
collect from the one or more sensors, second sensor data regarding the GHG emission level of the process at a second time after the first time;
calculate an updated GHG emission metric based on the second sensor data; and
in response to the updated GHG emission metric being less than the baseline GHG emission metric, mint an exhaustible non-fungible token with a value representing a difference between the updated GHG emission metric and the baseline GHG emission metric.
